(19) United States
(12) Patent Application Publication
(10) Pub. No.: US 2018/0260784 A1
(43) Pub. Date: Sep. 13, 2018

(54) ELECTRONIC DEVICE AND SCHEDULE UI PROVIDING METHOD THEREOF

(71) Applicant: SAMSUNG ELECTRONICS CO., LTD., Suwon-si (KR)

(72) Inventors: Hae-in LEE, Seongnam-si (KR); Sung-hye LEE, Seoul (KR)

(73) Assignee: SAMSUNG ELECTRONICS CO., LTD., Suwon-si (KR)

(21) Appl. No.: 15/916,734

(22) Filed: Mar. 9, 2018

Related U.S. Application Data
(60) Provisional application No. 62/469,024, filed on Mar. 9, 2017.

(30) Foreign Application Priority Data
Jul. 5, 2017 (KR) 10-2017-0085216

(51) Int. Cl. G06Q 10/10; G06F 3/0484; G06F 3/0481

(52) U.S. Cl. CPC G06Q 10/1093; G06F 3/04817; G06F 3/04842

(57) ABSTRACT

An electronic device and a schedule user Interface (UI) providing method thereof are provided. The method may include arranging and displaying a plurality of items corresponding to a plurality of schedules in a line according to time information and priority information included in the plurality of items in a schedule UI, receiving a user command for inputting a new first schedule in the schedule UI, and in response to a second schedule of which time overlaps with time of the input first schedule being present among the plurality of schedules, displaying an indicator in one of a first item corresponding to the first schedule and a second item corresponding to the second schedule according to a priority of the first schedule and the second schedule.

### CROSS-REFERENCE TO RELATED APPLICATIONS

This application claims priority from Korean Patent Application No. 10-2017-0085216, filed in the Korean Intellectual Property Office on Jul. 5, 2017, and U.S. Provisional Application No. 62/469024, filed in the U.S. Patent and Trademark Office on Mar. 9, 2017, the disclosures of which are incorporated herein by references in their entirety.

### BACKGROUND

### 1. Field

Aspects of the example embodiments relate to an electronic device and a schedule User Interface (UI) providing method thereof, more particularly, a schedule UI providing method for checking a schedule with a higher priority if time of a plurality of schedules overlaps with each other.

### 2. Description of the Related Art

There have been a variety of schedule management methods and programs for notifying a user of a schedule. Such schedule management programs are usually used in a mobile device such as a smartphone.

However, as a schedule management screen provided in a mobile device has a limited size, only the simple information such as a title, time, etc. of schedule can be displayed in the screen, and it is difficult to display specific details of schedule on the screen. Also, a schedule management screen can be displayed centering on a timeline or centering on an event, and the ways of displaying a schedule management screen could differ depending on whether a user considers a time of schedule important or considers an event of schedule important.

For example, in the case of the method of displaying a schedule management screen centering on a timeline, a user may easily check a start time and an end time of a schedule designated by a user with reference to one of axes (a horizontal axis or a vertical axis) in the schedule management screen, whereas the method of displaying a schedule management screen centering on a timeline has an advantage that a user can check a current schedule easily, but there is also a drawback that it is difficult to check a certain event at once.

In the case of a schedule management method which displays a schedule by an event unit, a schedule is displayed centering on an event, and thus, there is an advantage that a user can easily find an event that the user wants on the schedule management screen. However, as the schedules are arranged by an event unit, it is difficult to check a start time and an end time of a schedule instantly.

Also, if time of a plurality of schedules overlaps with each other, it is impossible to check which schedule is more important on the schedule management screen displayed by an event unit because there is no particular information of whether time of schedules overlaps with each other and a priority of each schedule.

### SUMMARY

Additional aspects and/or advantages will be set forth in part in the description which follows and, in part, will be apparent from the description, or may be learned by practice of the invention.

An aspect of example embodiments relates to a schedule management method and an electronic device which allows a user to check a schedule item for a certain event and to check a schedule with a higher priority than a priority of the schedule of the certain event instantly by displaying an indicator which informs a priority of another schedule item in a schedule item corresponding to the certain schedule.

According to an example embodiment, a schedule UI providing method of an electronic device is provided, the method including arranging and displaying a plurality of items corresponding to a plurality of schedules in a line according to time information and priority information included in the plurality of items in a schedule UI, receiving a user command for inputting a new first schedule in the schedule UI, and in response to a second schedule of which time overlaps with time of the input first schedule being present among the plurality of schedules, displaying an indicator in one of a first item corresponding to the first schedule and a second item corresponding to the second schedule according to a priority of the first schedule and the second schedule.

The displaying an indicator may include displaying an indicator in an item with a low priority between the first item and the second item.

The plurality of items may have priorities such that an item which is input later has a higher priority according to an order of input of the plurality of items.

The indicator may be displayed in a bar shape in at least one of up, down, left and right sides of an item.

The plurality of items may be disposed such that an item with an earlier start time may be disposed on an upper end, and an item with a later start time may be disposed on a lower end according to a start time of the schedule.

In response to a schedule start time of at least two items among the plurality of items being same, an item with a higher priority between the at least two items may be disposed on an upper end, and an item with a lower priority may be disposed on a lower end.

The indicator displayed in the item with a lower priority may have at least one of a shape, a color, and a brightness which correspond to the item with a higher priority.

The displaying an indicator may include, in response to there being a plurality of schedules of which time overlaps with time of the first schedule, a plurality of indicators corresponding to a schedule with a higher priority than a priority of the first schedule may be displayed in the first item corresponding to the first schedule, and the plurality of indicators may be arranged and displayed according to a priority of a plurality of items corresponding to the plurality of indicators in the first item.

The method may further include displaying, by the schedule UI, a summary item which summarizes a schedule according to time information and priority information included in the plurality of items, wherein the summary item may display a plurality of indicators corresponding to the plurality of items in the summary item based on time information of the plurality of items, and in response to an indicator for the plurality of items overlapping with the summary item and being displayed, an indicator of an item with a higher priority among the plurality of items may be displayed in the summary item.

The method may further include, in response to an input of a user command for the indicator, displaying schedule information of an item corresponding to the indicator.

According to an example embodiment, an electronic device is provided, the electronic device including an input unit, a display, and a processor configured to control the display to arrange and display a plurality of items corresponding to a plurality of schedule in a line according to time information and priority information included in the plurality of items in a schedule UI, to receive a user command for inputting a new first schedule in the schedule UI via the input unit, and in response to a second schedule of which time overlaps with time of the first schedule being present among the plurality of schedules, to control the display to display an indicator in one of a first item corresponding to the first schedule and a second item corresponding to the second schedule according to a priority of the first schedule and the second schedule and display the first item in the schedule UI according to time information and priority information included in the first item.

The processor may be further configured to control the display to display the indicator in an item with a low priority between the first item and the second item.

The plurality of items may have priorities such that an item which is input later may have a higher priority according to an order of input of the plurality of items.

The processor may be further configured to control the display to display the indicator in a bar shape in at least one of up, down, left and right sides of the item.

The processor may be further configured to control the display to dispose the plurality of items such that an item with an earlier start time may be disposed on an upper end, and an item with a later start time may be disposed on a lower end according to a start time of the schedule.

The processor may be further configured to, in response to a schedule start time of at least two items among the plurality of items being same, control the display to dispose an item with a higher priority between the at least two items on an upper end and dispose an item with a lower priority on a lower end.

The indicator displayed in the item with a lower priority may have at least one of a shape, a color, and a brightness which correspond to the item with a higher priority.

The processor may be further configured to, in response to there being a plurality of schedules of which time overlaps with time of the first schedule, control the display to display a plurality of indicators corresponding to a schedule with a higher priority than a priority of the first schedule in the first item corresponding to the first schedule, and the processor may also be configured to control the display to arrange and display the plurality of indicators according to a priority of a plurality of items corresponding to the plurality of indicators and display in the first item.

The processor may be further configured to control the display to display a summary item which summarizes a schedule according to time information and priority information included in the plurality of items by the schedule UI, to control the display to display a plurality of indicators corresponding to the plurality of items in the summary item based on time information of the plurality of items, and in response to an indicator for the plurality of items overlapping with the summary item and being displayed, to control the display to display an indicator of an item with a higher priority among the plurality of items in the summary item.

The processor may be further configured to, in response to receiving a user command for the indicator, control the display to display schedule information of an item corresponding to the indicator.

As described above, according to various example embodiments, a user may identify a priority of a plurality of schedules at once by using an indicator displayed in a certain event item in a schedule management screen.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating an example configuration of an electronic device 100 according to an example embodiment;

FIG. 2 is a block diagram illustrating an example configuration of an electronic device according to an example embodiment;

FIG. 3 is a diagram illustrating an example of a schedule UI screen according to an example embodiment;

FIGS. 4A and 4B are diagrams illustrating an example of a schedule UI displaying method in response to there being no items of which time overlaps with time of another item according to an example embodiment;

FIGS. 5A, 5B, 5C, and 5D are diagrams illustrating an example of a schedule UI displaying method in response to there being items of which time overlaps with time of another item according to an example embodiment;

FIGS. 6A, 6B, and 6C are diagrams illustrating an example of an indicator displaying method according to an example embodiment;

FIGS. 7A, 7B and 7C are diagrams illustrating an example of a schedule UI displaying method of an electronic device according to an example embodiment;

FIG. 8 is a diagram illustrating an example of a summary item according to an example embodiment;

FIG. 9 is a diagram illustrating an example of a digital signage management system using a schedule management method according to an example embodiment;

FIGS. 10A, 10B, 100, 10D, and 10E are diagrams illustrating an example of a schedule input method according to an example embodiment; and

FIG. 11 is a flowchart illustrating an example of a schedule UI providing method of an electronic device according to an example embodiment.

### DETAILED DESCRIPTION

The example embodiments may vary, and may be provided in different example embodiments. Specific example embodiments will be described with reference to accompanying drawings and detailed explanation. However, this does not necessarily limit the scope of the example embodiments to a specific embodiment form. Instead, modifications, equivalents and replacements included in the disclosed concept and technical scope of this description may be employed. However, this does not necessarily limit the scope of the example embodiments to a specific embodiment form. Instead, modifications, equivalents and replacements included in the disclosed concept and technical scope of this description may be employed. In the following description, well-known functions or constructions are not described in detail since they would obscure the application with unnecessary detail.

The terms including ordinal number such as “first,” “second,” and so on may be used in the description and the claims to distinguish the elements from one another. These terms are used only for the purpose of differentiating one component from another, without limitation thereto.

The terms used in the following description are provided to explain a specific example embodiment and are not intended to be limiting. A singular term includes a plural form unless otherwise indicated. The terms, “include,” “comprise,” “is configured to,” etc. of the description are used to indicate the presence of features, numbers, steps, operations, elements, parts or combination thereof, and do not exclude the possibilities of combination or addition of one or more features, numbers, steps, operations, elements, parts or combination thereof.

In an example embodiment, ‘a module’ or ‘a unit’ performs at least one function or operation, and may be realized as hardware, software, or combination thereof. Further, except the “modules” or “units” that have to be implemented by certain hardware, a plurality of “modules” or a plurality of “units” may be integrated into at least one module and realized as at least one processor (not illustrated).

Hereinafter, various example embodiments will be described in greater detail with reference to the accompanying drawings so as for a person having ordinary skill in the art to easily implement the example embodiments. However, the example embodiment may be implemented in various ways, and are not limited to the example embodiments described herein. In addition, illustration of parts having nothing to do with the explanation of the present disclosure is omitted from the drawings to clearly explain the present disclosure. Throughout the specification, similar reference numerals are used for similar elements.

Meanwhile, the example embodiments will be described with reference to an example of a method for managing a schedule of a certain date. However, the example embodiments are not limited to the above example, but the technical essence may be applied to a schedule of a different period such as a certain week, month, year, etc.

Hereinafter, the example embodiments will be described in detail with reference to the accompanying drawings.

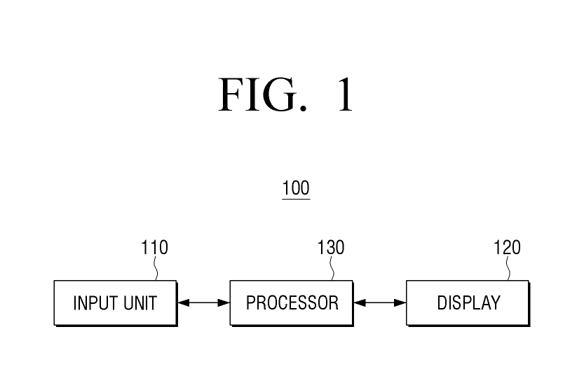

FIG. 1 is a block diagram illustrating an example configuration of an electronic device 100 in accordance with an example embodiment. The electronic device 100 may include at least one of, for example, a smartphone, a tablet PC, a mobile phone, a video phone, a desktop, a laptop, a netbook computer, a workstation, a personal digital assistant (PDA), a portable multimedia player (PMP), or a wearable device.

As illustrated in FIG. 1, the electronic device 100 may include an input unit 110, a display 120 and a processor 130.

The input unit 110 may receive a user command for controlling the electronic device 100. For example, the input unit 110 may receive an input of user command for inputting a schedule in a schedule UI.

The display 120 may display a schedule UI under control of the processor 130. For example, the display 120 may display an item corresponding to a schedule included in a schedule UI (or Graphical User Interface—GUI), an indicator displayed on an item, and various Uls for generating an item. The indicator may indicate priority information of an item corresponding to a schedule, and may include the information on an item corresponding to a schedule.

The processor 130 may control overall operations of the electronic device 100. For example, the processor 130 may control the display 120 to display a schedule UI including a plurality of items corresponding to a plurality of schedules. When a user command for inputting a first schedule is input via the input unit 110, the processor 130 may identify whether there is a schedule which overlaps with the first schedule among the plurality of schedules displayed on the display. If there is a second schedule which overlaps with the first schedule, the processor 130 may control the display 120 to display an indicator in one of a first item corresponding to the first schedule and a second item corresponding to the second item according to a priority of the first schedule and the second schedule.

If a priority of the first schedule is lower than a priority of the second schedule, the processor 130 may control the display 120 to display an indicator in the first item corresponding to the first schedule. In the below description, the example embodiment in which an indicator is displayed in an item with a low priority will be described, but the example embodiments are not limited thereto. The indicator may be displayed in an item with a high priority.

The indicator displayed in the first item may be associated with the second schedule. For example, an indicator displayed in the first item may include the information on at least one of a shape, a color, and a brightness which correspond to an item corresponding to the second schedule. For example, if the first item is displayed red and the second item is displayed blue, an indicator for the second item which is displayed in the first item may be blue, which is the same as the color of the second item.

The item which corresponds to a schedule may include priority information. The priority of a schedule may be determined by various methods. As an example, the priority may be determined according to an order of input of schedules. Accordingly, the processor 130 may identify that the item which is input later has the highest priority. For example, if the first to fourth items which correspond to the first to fourth schedules are input in an order of the first item, the second item, the third item and the fourth item, the processor 130 may identify that the fourth item which is most recently input has the highest priority. By the same method, the processor 130 may identify that an order of a priority of the first to third items is the third item, the second item, and the first item.

However, the example embodiments of identifying a priority are not limited to the above example, but a priority may be determined by various methods. For example, if a user command for a priority is input via the input unit 110, the processor 130 may identify a priority of a schedule according to the input user command. The priority may also be determined by various ways depending on whether a same schedule has been input, whether there is a length of time corresponding to a schedule, etc.

The processor 130 may control the display 120 to display an indicator displayed on an item in one of up, down, left and right sides of the item in a bar shape. However, the examples of the shape of an indicator are not limited to the above example, but the indicator may be displayed in various shapes such as a circle, a quadrangle, etc.

The processor 130 may control the display 120 to arrange and display a plurality of items corresponding to a plurality of schedules in accordance with a predetermined reference. For example, the processor 130 may control the display 120 to arrange and display a plurality of items according to time information included in a plurality of items. For example, a plurality of items are arranged vertically, the processor 130 may control the display 120 to dispose and display an item with an earlier start time on an upper end, and an item with a later start time on a lower end according to a start time of a schedule. Also, if a plurality of items are arranged horizontally, the processor 130 may control the display 120 to display the plurality of items from the left side to the right side according to a start time of a schedule by the same method above.

If there are at least two items which have a same start time among a plurality of arranged items, the processor 130 may control the display 120 to arrange and display the at least two items according to a priority of the items. For example, the processor 130 may control the display 120 to dispose and display an item with a higher priority on an upper end, and an item with a lower priority on a lower end. However, the example embodiments are not limited to the above example, but the processor 130 may control the display 120 to arrange and display an item with a lower priority first.

If there are a plurality of schedules of which time overlaps with time of the first schedule, the processor 130 may identify a schedule with a higher priority than a priority of the first schedule among the plurality of schedules of which time overlaps with time of the first schedule. The processor 130 may control the display 120 to display an indicator corresponding to a schedule with a higher priority than a priority of the first schedule among the schedules of which time overlaps with time of the first schedule in the first item corresponding to the first schedule.

If there are a plurality of indicators displayed in the first item, the processor 130 may identify a priority of a plurality of schedules corresponding to a plurality of indicators, and control the display 120 to display a plurality of indicators in the first item according to the identified priority. For example, if there are the second, third, and fourth schedules of which time overlaps with time of the first schedule and which have a high priority, the processor 130 may control the display 120 to display the second, third, and fourth indicators corresponding to the second, third, and fourth schedules in the first item. The second, third, and fourth indicators may be displayed according to a priority of the second, third, and fourth schedules. For instance, if an order of a priority is the second schedule, the third schedule, and the fourth schedule, the processor 130 may control the display to display the second, third, and fourth indicators from the left side in order. The above example embodiment will be described in detail later.

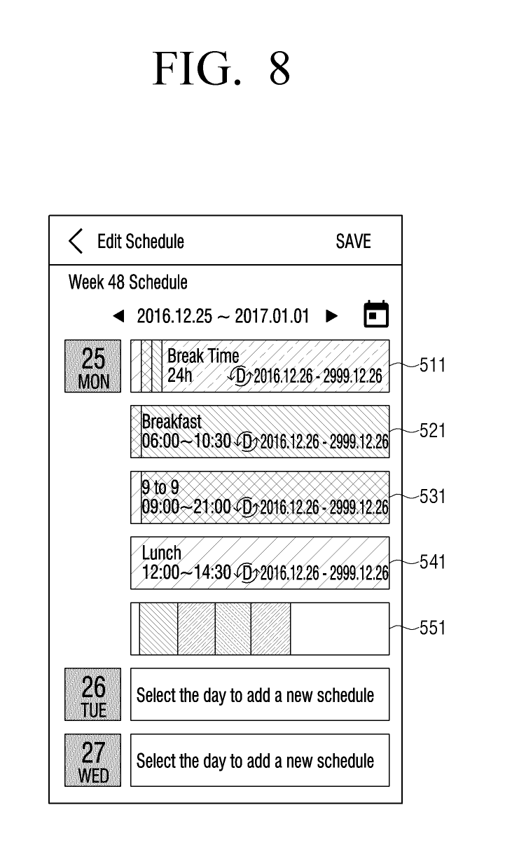

The processor 130 may control the display 120 to display a summary item which summarizes the information of a plurality of items corresponding to a plurality of schedules. In the example embodiment, a summary item for a schedule of a certain date will be described, but the example embodiments are not limited thereto. The processor 130 may control the display 120 to display a summary item for a schedule of various periods such as a certain month, a certain year, etc. The summary item will be described in detail later with reference to FIG. 8.

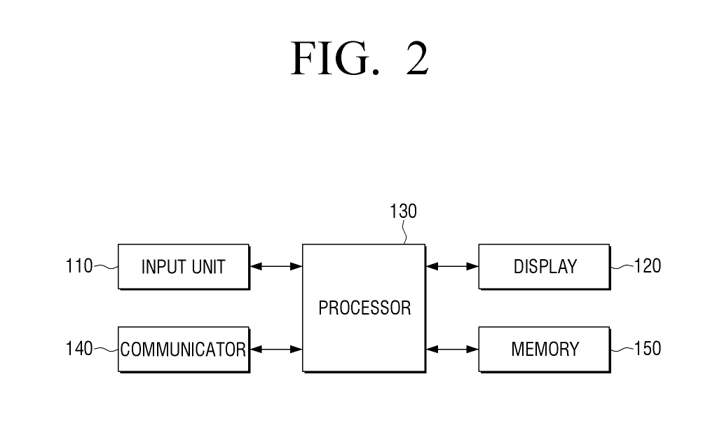

FIG. 2 is a block diagram illustrating an example configuration of an electronic device in accordance with an example embodiment. As illustrated in FIG. 2, the electronic device 100 may further include a communicator 140 and a memory 150 in addition to the input unit 110, the display 120 and the processor 130. The example configuration described in FIG. 2 is merely one example embodiment, and some of the elements may be added or omitted if necessary.

The input unit 110 may receive a user command as described above. The input unit 110 may be combined with the display 120 and a touch sensing unit (not illustrated) and be implemented as a touch screen. However, the example embodiments are not limited to the above example. The input unit 110 may include a button, or be implemented as an external remote controller. If the input unit 110 is implemented as an external remote controller, a user command may be received via the communicator 140.

The display 120 may be implemented as various forms of a display panel. For example, the display panel may be implemented by various display technology, such as a liquid crystal display (LCD), an organic light emitting diodes (OLED), an active-matrix organic light-emitting diode (AM-OLED), a liquid crystal on silicon (LcoS), or a digital light processing (DLP), etc. Also, the display 120 may be mounted on one of a front area, a side area, and a rear area of the electronic device 100 in a form of a flexible display.

The display 120 may display a schedule UI under control of the processor 130. For example, the display 120 may display an item corresponding to a schedule included in a schedule UI, an indicator displayed on an item, various Uls for generating an item. However, the example embodiments are not limited to the above example, and the display 120 may also output various image content.

The communicator 140 may communicate with an external device. The communicator 140 may include various communication chips such as a W-Fi chip, a Bluetooth chip, a NFC chip, a wireless communicator chip, etc. The Wi-Fi chip, the Bluetooth chip and the NFC chip may communicate by a Wi-Fi method, a Bluetooth method, and an NFC method, respectively. When using the Wi-Fi chip or Bluetooth-chip, various connection information such as an SSID, a session key, etc., may be firstly transmitted and received, communication connection may be performed using the information, and various information may be transmitted and received. The wireless communication chip may refer to the chip which communicates according to various communication protocols, such as IEEE, ZigBee, 3rd Generation (3G), 3rd Generation Partnership (3GP), Long Term Evolution (LTE), or the like.

If the input unit 110 is implemented as an external remote controller, the communicator 140 may receive a user command from an external remote controller. Also, the communicator 140 may transmit schedule information to an external device. When the schedule information is transmitted to an external device, the communicator 140 may further transmit to the external device the information about the function/operation which the external device needs to perform in relation to the corresponding schedule.

The memory 150 may store various programs and data required for operating the electronic device 100. The memory 150 may be implemented as a non-volatile memory, a volatile memory, a flash memory, a hard disk drive (HDD), a solid state drive (SSD), etc. In the example embodiment, the term ‘memory’ may include the memory 150, a ROM and a RAM provided in the processor 130, or a memory card (not illustrated) (e.g., a micro SD card, a memory stick, etc.) provided in the electronic device 100.

The memory 150 may store various content including a photo, music, etc. The various stored content may be transmitted to an external device with schedule information, which will be describe later.

The processor 130 may receive a command from at least one of the input unit 110, the display 120, the communicator 140, and the memory 150 via a bus, decode the received command, and perform a calculation or a data processing operation according to the decoded command. According to various example embodiments, the processor 130 may be a multi-core processor.

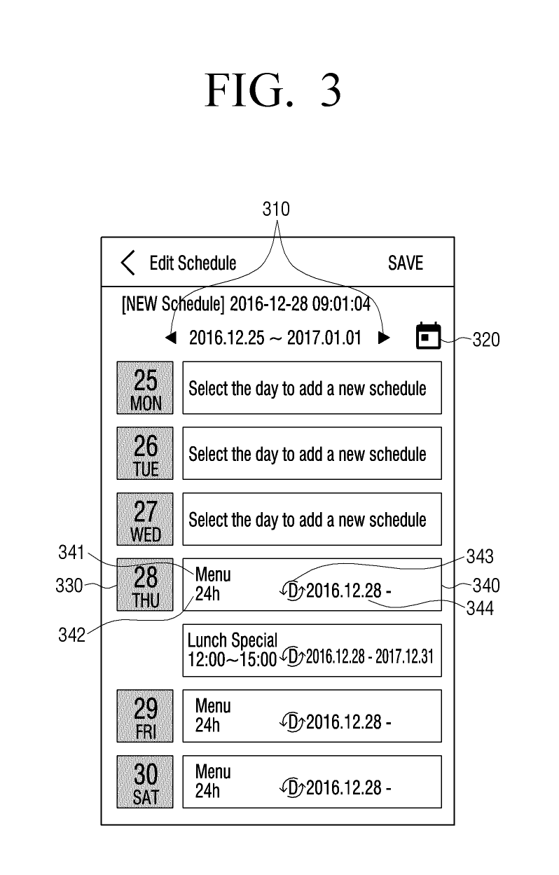

A schedule providing method will be described below with reference to FIGS. 3 to 8 in accordance with an example embodiment.

FIG. 3 is a diagram illustrating an example of a schedule UI screen in accordance with an example embodiment. As illustrated in FIG. 3, the schedule UI may include a week's schedule moving icon 310, a today's schedule shortcut icon 320, a date displaying icon 330, and an item icon corresponding to a schedule 340.

For example, the week's schedule moving icon 310 may be for displaying a schedule UI screen of last week's or next week's schedule. For example, if a user command of touching the week's schedule moving icon 310 is received, the electronic device 100 may display a schedule UI screen corresponding to the user command. Also, if a user command of touching the today's schedule shortcut icon 320 is received, the electronic device 100 may display a schedule UI screen including a today's date. Also, if a user command of touching the date displaying icon 330 is received, the electronic device 100 may display a screen for generating or editing a schedule of the corresponding date.

Also, the item icon corresponding to a schedule 340 (hereinafter, will be referred to as an item) may include the information about a title 341, a schedule start/end time 342, a repetition period 343, and a schedule start/end date 344. Also, the item 340 may further include an indicator 345 which indicates priority information. If there is no satisfactory priority indicator 345, the item 340 may not display the indicator 345. In the below description, a method for displaying an indicator in a plurality of items corresponding to a plurality of schedules will be described. In addition to the above-described elements, the item may include various information if necessary. For example, the item may further include date information of a schedule, link information related to a schedule, etc.

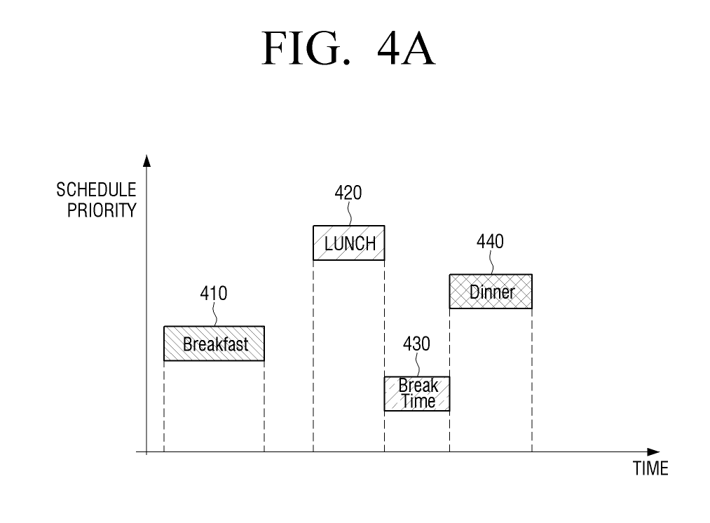

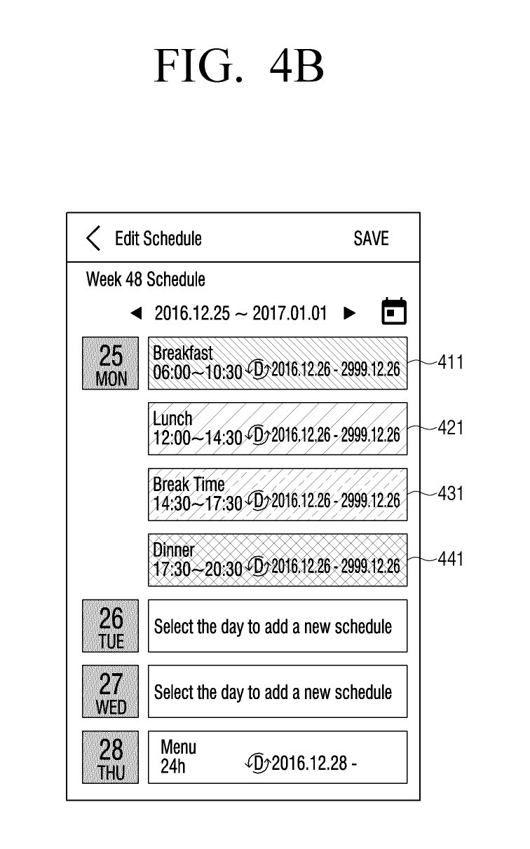

FIGS. 4A and 4B are diagrams illustrating an example of a schedule UI displaying method when there is no item of which time overlaps with time of another item in accordance with an example embodiment.

For example, FIG. 4A is a graph showing a priority, time information, and schedule information of a registered schedule. The horizontal axis is a time axis, and the vertical axis is a priority axis. As illustrated in FIG. 4A, the first schedule 410 may be input in the time of 06:00˜10:30, the second schedule 420 in 12:00˜14:30, the third schedule 430 in 14:30˜17:30, and the fourth schedule in 17:30˜20:30 in the electronic device 100. The order of a priority may be the second schedule 420, the fourth schedule 440, the first schedule 410, and the third schedule 430.

As illustrated in FIG. 4B, when a user command for inputting a schedule is input, the electronic device 100 may display the first to fourth items 411, 421, 431, and 441 on a schedule UI. The plurality of items may be arranged following an order of a schedule start time. In other words, as illustrated in FIG. 4B, the first item 411 with the earliest start time may be displayed on the top end, and the fourth item 441 with the latest start time may be displayed on the lowest end. However, the example embodiments are not limited to the above example. The item arrangement order may be determined depending on various conditions. For example, if a plurality of items are arranged according to a priority, the plurality of items may be arranged in an order of the second item 421, the fourth item 441, the first item 411, and the third item 431.

In FIGS. 4A and 4B, the time information of the first to fourth items does not overlap with each other. Thus, in this case, an indicator may not be displayed in the items which are displayed on a schedule item.

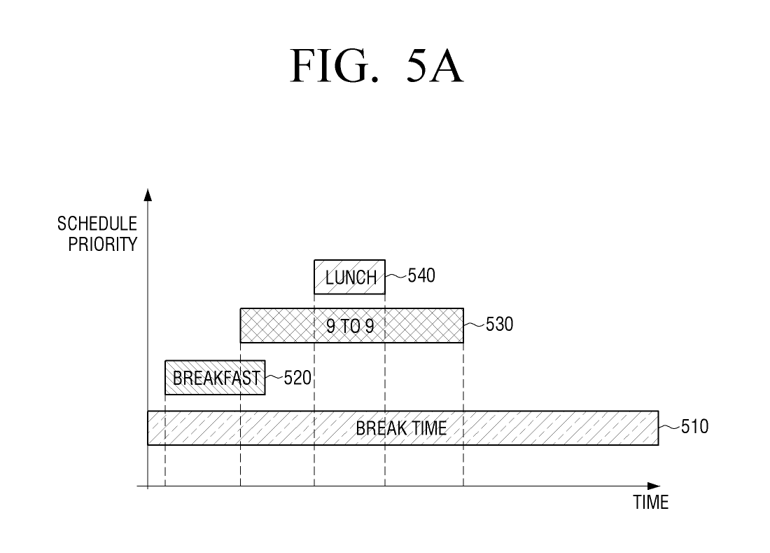

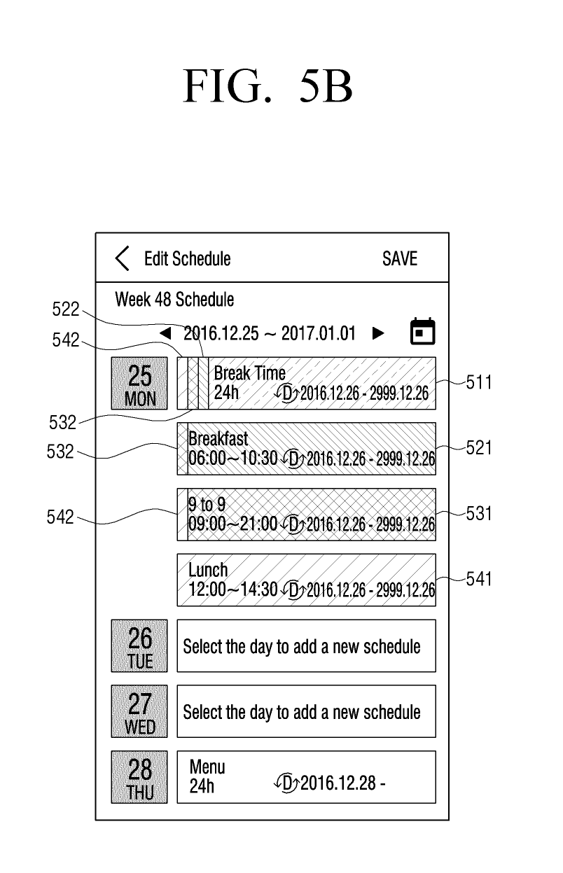

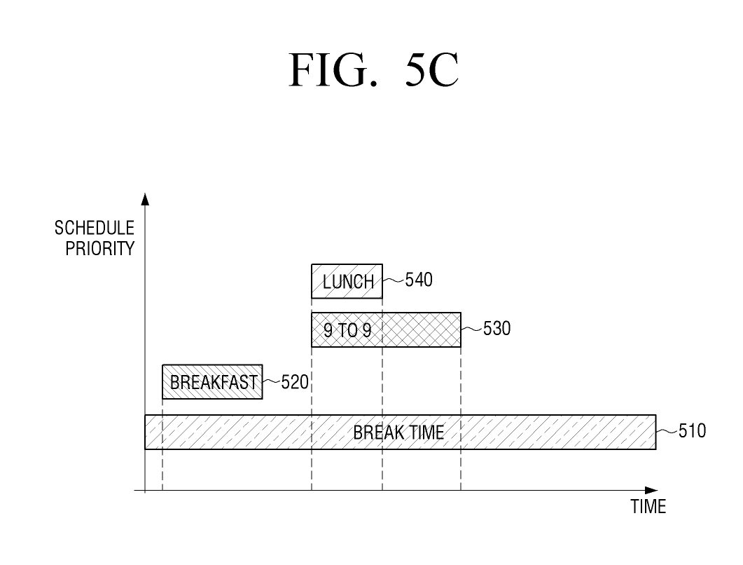

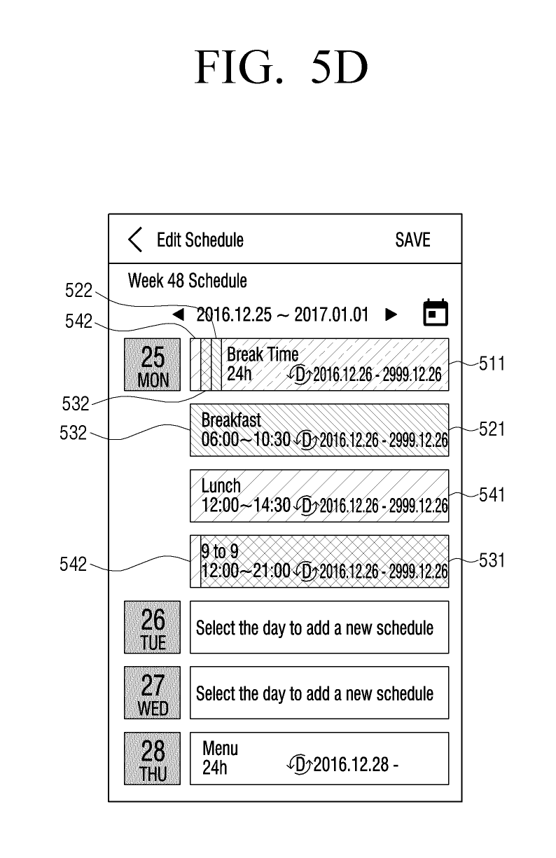

FIGS. 5A, 5B, 5C and 5D are diagrams illustrating an example of a schedule UI displaying method when there is an item of which time overlaps with time of another item in accordance with an example embodiment. A method for configuring a screen of a schedule management UI using schedule information illustrated in FIG. 5A will be described below. However, the example embodiments are not limited to the above example, but the technical essence may be applied to displaying of a variety of schedule information.

For example, as illustrated in FIG. 5A, the first schedule 510 may be input in the time of 00:00˜24:00, the second schedule 520 in 06:00˜10:30, the third schedule 530 in 09:00˜21:00, and the fourth schedule 540 in 12:00˜14:30 in the electronic device 100. As described above, a priority of a schedule may be determined according to a schedule input order. Thus, the order of a priority may be determined such that the fourth schedule 540 which is input most lately may have the highest priority, and the third schedule 530 and the second schedule 520 may be the next, and the first schedule 510 which is input first may have the lowest priority. In other words, the priority of a schedule may be determined in an inverse order of an input order, that is, the fourth schedule 540, the third schedule 530, the second schedule 520 and the first schedule 510.

As illustrated in FIG. 5B, if a user command for inputting a schedule is input, the electronic device 100 may display the first to fourth items 511, 521, 531 and 541 in a schedule UI. As described above, a plurality of items may be arranged in an order of a start time of a schedule.

For example, as illustrated in FIG. 5B, the start time of the first item 511 is 00:00, the start time of the second item 521 is 06:00, the start time of the third item 531 is 09:00, and the start time of the fourth item 541 is 12:00. Thus, the first item 511 of the earliest start time may be arranged on the top end, and the fourth item 541 of the latest start time may be arranged at the lowest end.

If a start time of at least two items among a plurality of items is the same, the at least two items having the same start time may be arranged according to a priority. For example, as illustrated in FIGS. 5C and 5D, if the start time of the third item 531 and the fourth item 541 are the same, the fourth item 541 with a higher priority may be arranged on an upper end than the third item 531.

Referring back to FIG. 5B, an indicator for priority information may be displayed in the first item 511, the second item 521, and the third item 531. For example, the electronic device 100 may identify whether the time of the first schedule 510 overlaps with the time of the second to fourth schedules 520, 530, and 540. As the time of the first schedule overlaps with the time of the second to fourth schedules 520, 530, and 540, the electronic device 100 may identify a priority of the first schedule 510 and the second to fourth schedules 520, 530, and 540. If there is a schedule with a higher priority than a priority of the first schedule 510, the electronic device 100 may display an indicator informing that there is a schedule with a higher priority in the first item 511 corresponding to the first schedule. However, as described above, the electronic device may display an indicator to inform that there is a schedule with a lower priority in the first item 511 corresponding to the first schedule, but in the example embodiment, the example of displaying an indicator informing that there is a schedule with a higher priority will be described.

In other words, in the example embodiment of FIG. 5B, the electronic device 100 may display an indicator in the left side of the first item 510 in a bar shape. The indicator displayed in the first item may be the second to fourth indicators 522, 532, and 542 which correspond to the second to fourth schedules 520, 530, and 540. The second to fourth indicators 522, 532, and 542 which are displayed in the first item may include at least one of a shape, a color, and a brightness which correspond to the second to fourth items 520, 530, and 540. For example, if the first item 511 is displayed green, the second item 521 is displayed blue, the third item 531 is displayed orange, and the fourth item 541 is displayed purple, the second indicator 522 may be blue, the third indicator 532 may be orange, and the fourth indicator 542 may be purple.

Also, as illustrated in FIG. 5B, the second to fourth indicators 522, 532, and 542 may be displayed in the first item according to a priority of the second item 521, 531, and 541. In other words, the electronic device 100 may display an indicator from the left side of the first item 510 in an order of the fourth indicator 542, the third indicator 532, and the second indicator 522.

The electronic device 100 may display an indicator in the second to fourth items 521, 531, and 541 by the same method as above. For example, the electronic device may identify whether there is a schedule of which time overlaps with time of the second schedule. The schedule of which the time overlaps with the time of the second schedule 520 may be the first schedule 510 and the third schedule 530. The electronic device 100 may identify a priority of the second schedule 520 and a priority of the first and third schedules 510 and 530. The order of a priority of the schedules may be the third schedule 530, the second schedule 520, and the first schedule 510. The electronic device 100 may display the third indicator 532 corresponding to the third schedule 530 with a higher priority than a priority of the second schedule 520 in the left side of the second item 520 in a bar shape.

The electronic device 100 may identify whether there is a schedule of which time overlaps with the time of the third schedule 530 by the same method. The schedule of which time overlaps with the time of the third schedule 530 may be the first schedule 510, the second schedule 520, and the fourth schedule 540. The electronic device 100 may identify a priority of the third schedule 530 and a priority of the first, second, and fourth schedules 510, 520, and 540. An order of a priority of a schedule may be the fourth schedule 540, the third schedule 530, the second schedule 520 and the first schedule 510. The electronic device 100 may display the fourth indicator 542 corresponding to the fourth schedule 540 with a higher priority than a priority of the third schedule 530 in the left side of the third item 530 in a bar shape.

The electronic device 100 may identify a schedule of which time overlaps with the time of the fourth schedule 540, and identify a priority of the schedule with an overlapping time and the fourth schedule 540. The time of the fourth schedule 540 may overlap with the time of the first schedule 510 and the third schedule 530. However, as a priority of the fourth schedule 540 is the highest, an indicator may not be displayed in the fourth item 542.

In the above example, it is described that the electronic device 100 may identify whether time of a certain schedule overlaps with time of another schedule and compare a priority of the other schedule with an overlapping time with a priority of the certain schedule, and display an indicator. However, the order of identifying a time overlap and determining a priority may be changed appropriately. In other words, the electronic device 100 may identify a schedule with a higher priority than a priority of a certain schedule, and if the time of the certain schedule overlaps with the time of one of the schedules with a higher priority, the electronic device 100 may display an indicator.

For example, the electronic device 100 may perform identifying of a time overlap and determining of a priority to the third item 531 and the fourth item 541 which have a higher priority than a priority of the second item 521, and determine the third item 531 of which time overlaps with the time of the second item 521 between the third item 531 and the fourth item 541. The electronic device 100 may also perform the identifying whether time overlaps and the determining a priority simultaneously.

FIGS. 5A to 5D illustrate the example in which the electronic device 100 displays an indicator in the left side of an item in a bar shape, but the example embodiments are not limited thereto. For example, the electronic device may display an indicator in at least one of up, down, left and right sides of an item, and may display an indicator in various shapes such as a quadrangle, a circle, etc., not being limited to a bar shape.

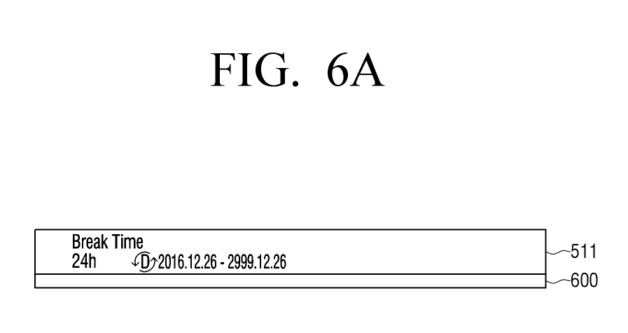

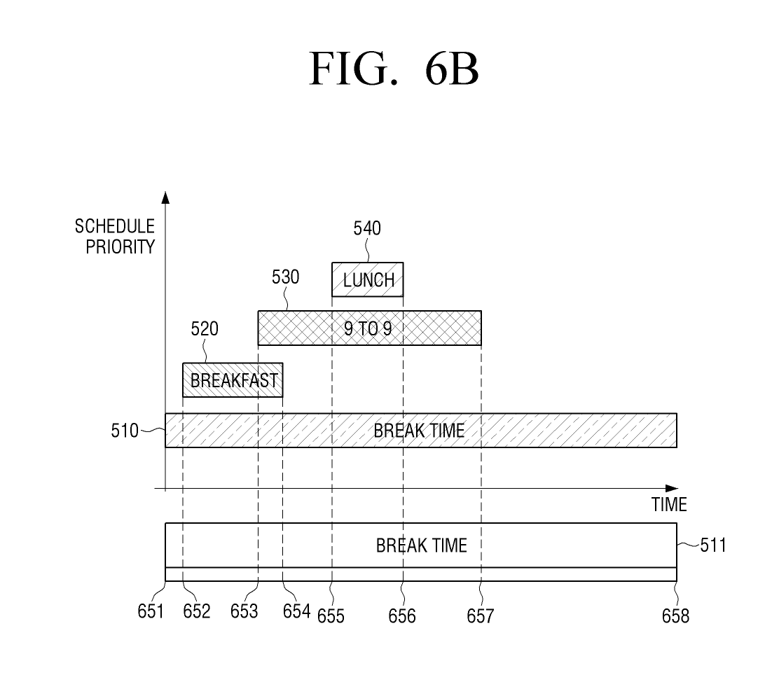

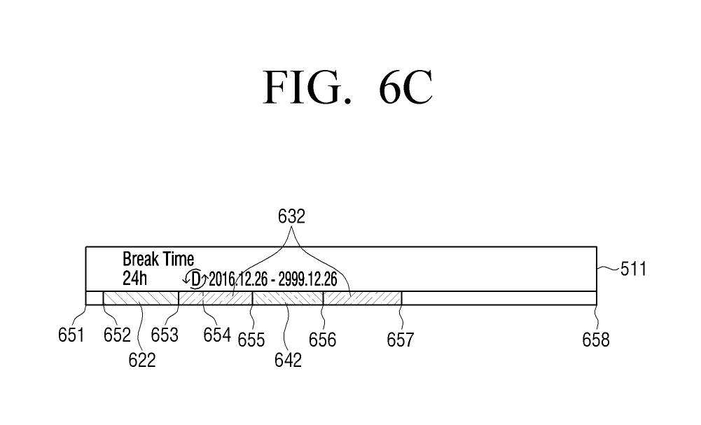

FIGS. 6A, 6B and 6C illustrate an example of an indicator displaying method in accordance with an example embodiment.

FIG. 6A illustrates an example of a method for displaying an indicator in a lower end of an item in a bar shape. For example, if a same schedule as in FIG. 5A is input, the electronic device 100 may display an indicator 612 corresponding to the first schedule and indicators 622, 632, and 642 which correspond to the second to fourth schedules 520, 530, and 540 on the lower end of the first item 511. The indicator displayed on the first item may be displayed based on the time information of a schedule corresponding to the indicator.

For example, as illustrated in FIG. 6A, the electronic device 100 may display an indicator bar UI 600 including a plurality of indicators on the lower end of the first item 511. FIG. 6B illustrates an example of a plurality of indicators displayed on the indicator bar UI 600.

The indicator displayed on the indicator bar UI 600 may be displayed based on the time information of a schedule corresponding to the indicator. For example, as illustrated in FIG. 6B, the first point 651 of the indicator bar UI 600 of the first item may correspond to the time 00:00, and the eighth point 658 may correspond to 24:00. The second indicator 522 may be displayed from the second point 652 to the fourth point 654 of the indicator bar UI 600. By the same method, the third indicator 532 may be displayed from the third point 653 to the seventh point 657 of the indicator bar UI 600, and the fourth indicator 542 may be displayed from the fifth point 655 to the sixth point 656 of the indicator bar UI 600. The indicator may be displayed based on the time information of a schedule corresponding to the indicator, and thus, the second point 652 may correspond to the time 06:00, the third point 653 may correspond to 09:00, the fourth point 654 may correspond to 10:30, the fifth point 655 may correspond to 12:00, the sixth point 656 may correspond to 14:30, and the seventh point 657 may correspond to 21:00.

According to FIG. 6B, the second to fourth indicators which are displayed in the indicator bar UI 600 may be overlapped with each other and displayed. For example, the second indicator and the third indicator may be overlapped from the third point 653 to the fourth point 654, and the third indicator and the fourth indicator may be overlapped from the fifth point 655 to the sixth point 656.

According to an example embodiment, if the indicators displayed in the indicator bar UI 600 are overlapped and displayed, the electronic device 100 may display an indicator corresponding to a schedule with a higher priority in the overlapping area, and may not display an indicator corresponding to a schedule with a lower schedule.

As illustrated in FIG. 6C, the electronic device 100 may display the second indicator from the second point 652 to the third point 653, display the third indicator from the third point 653 to the fifth point 655 and from the six point 656 to the seventh point 657, and display the fourth indicator from the fifth point 655 to the sixth point 656. In other words, if there is an overlapping area (that is, from the third point 653 to the fourth point 654) in which the second indicator and the third indicator overlap with each other, the electronic device 100 may display only the third indicator corresponding to the third schedule having a higher priority. Also, the electronic device 100 may display only the third indicator corresponding to the fourth schedule having a higher priority in response to the overlapping area (that is, from the fifth point 655 to the sixth point 656) in which the third indicator and the fourth indicator overlap with each other.

The electronic device 100 may display the first indicator in the area in which the second to fourth indicators are not displayed.

Also, the electronic device 100 may display an indicator in the second to fourth items 520, 530, and 540 by the same method described in the descriptions of FIGS. 6A to 6C.

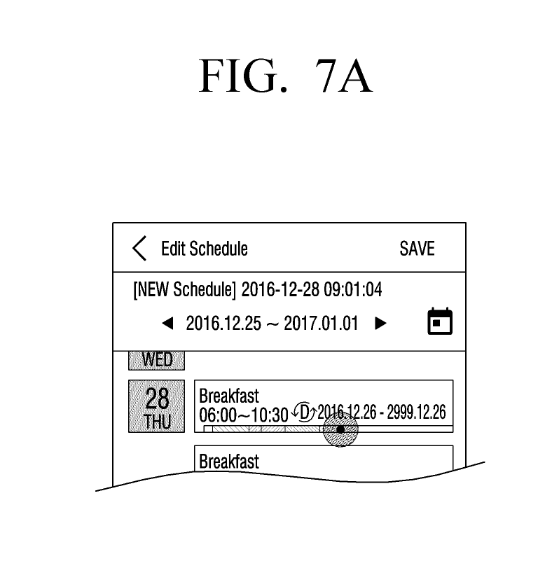

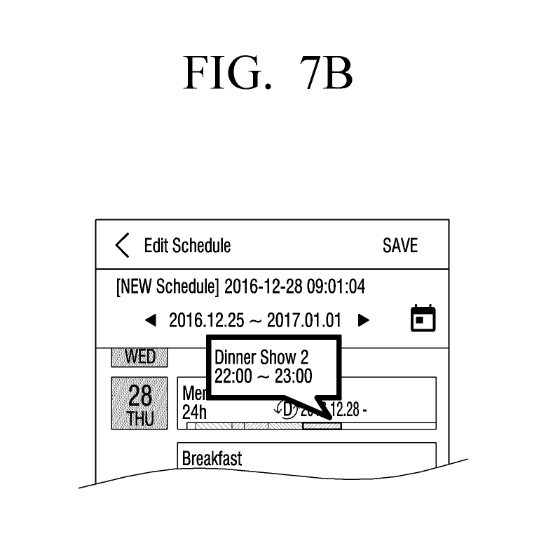

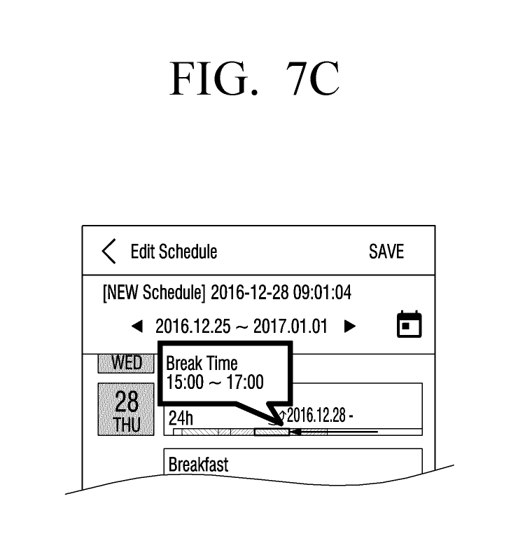

FIGS. 7A, 7B and 7C illustrate an example of a schedule UI displaying method in accordance with an example embodiment.

For example, as illustrated in FIG. 7A, when a user command for one of a plurality of indicators displayed in the first item 511 is input, the electronic device 100 may display schedule information corresponding to the indicator in which the user command is input as illustrated in FIG. 7B. The user command may be a touch input 710 which touches an indicator. For example, if a touch input is maintained for a predetermined period of time, the electronic device 100 may display schedule information corresponding to the touched indicator.

As illustrated in FIG. 7C, when a touch and drag input for moving an indicator while a touch input is maintained is received and the touched indicator is changed by the touch and drag input, the electronic device 100 may display schedule information corresponding to the changed indicator.

FIG. 8 illustrates an example of a summary item in accordance with an example embodiment. For example, the electronic device 100 may display a summary item which summarizes schedules of a day.

As illustrated in FIG. 8, a schedule management UI may further include a schedule summary item 551 in addition to a plurality of items 511, 521, 531, and 541. The left end of the summary item 551 may correspond to a start time (00:00) of a day, and the right end may correspond to an end time (24:00) of a day. The electronic device 100 may summarize and display schedules in the summary item 551 in a bar shape in accordance with time information of the first to fourth items 511, 521, 531, and 541.

As illustrated in FIGS. 6A to 6D, if a plurality of schedule overlap with one another, the electronic device 100 may display a schedule relating to an item which corresponds to a schedule with the highest priority in the summary item 551.

In other words, the summary item 551 may be displayed by the same method as the method of displaying the indicator bar UI 600 illustrated in FIG. 6C. In FIG. 6C, however, the left end and the right end of an item may be a start time and an end time of a schedule corresponding to a related item, but the left end and the right end of the summary item 551 may be a start time and an end time of a day.

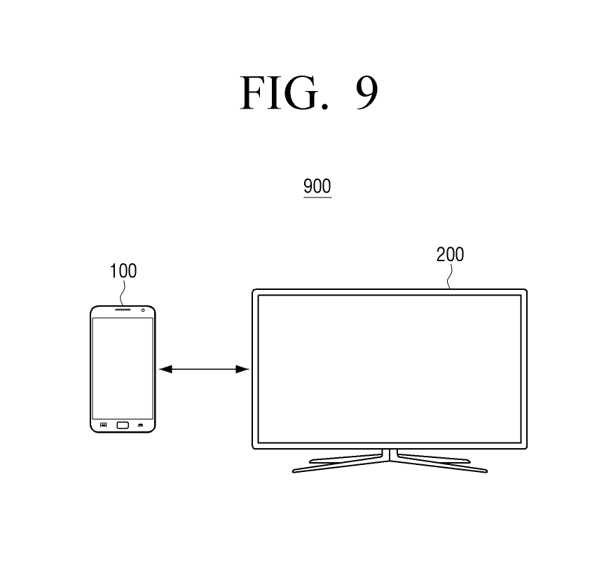

FIG. 9 illustrates an example of a digital signage management system using a schedule management method in accordance with an example embodiment.

For example, as illustrated in FIG. 9, a digital signage system 900 may include the electronic device 100 and the display device 200. The digital signage system may be utilized in various fields such as in a hospital, a restaurant, an outdoor advertisement, etc. However, the example embodiments are not limited to the above example, and the digital signage system 900 may further include an external server.

For example, when a schedule is input, the electronic device 100 may further receive an input of content information along with the information about a title, time, and a repetition period. The electronic device 100 may transmit the input schedule information to the display device 200. The display device 200 may display content information corresponding to a current schedule. If schedules overlap, the display device 100 may display content corresponding to a schedule with a higher priority.

For example, if the first content and the fourth content are stored in the first schedule 510 and the fourth schedule 540 illustrated in FIG. 5A, respectively, the electronic device 100 may transmit schedule information and content information to the display device 200. The display device 200 may display the first content in the time of 00:00˜06:00, the second content in 06:00˜09:00, the third content in 09:00˜12:00, the fourth content in 12:00˜14:30, the third content in 14:30˜21:00, and the first content in 21:00˜24:00.

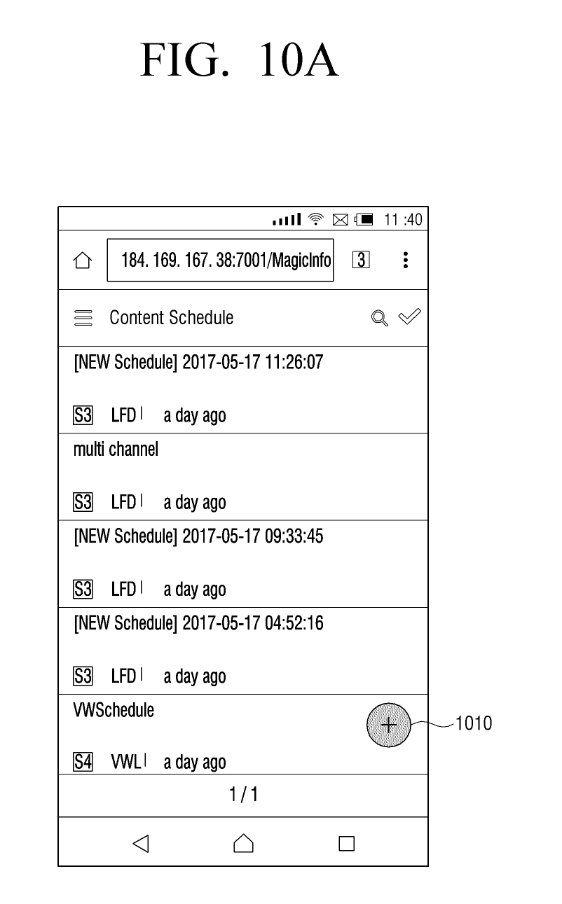

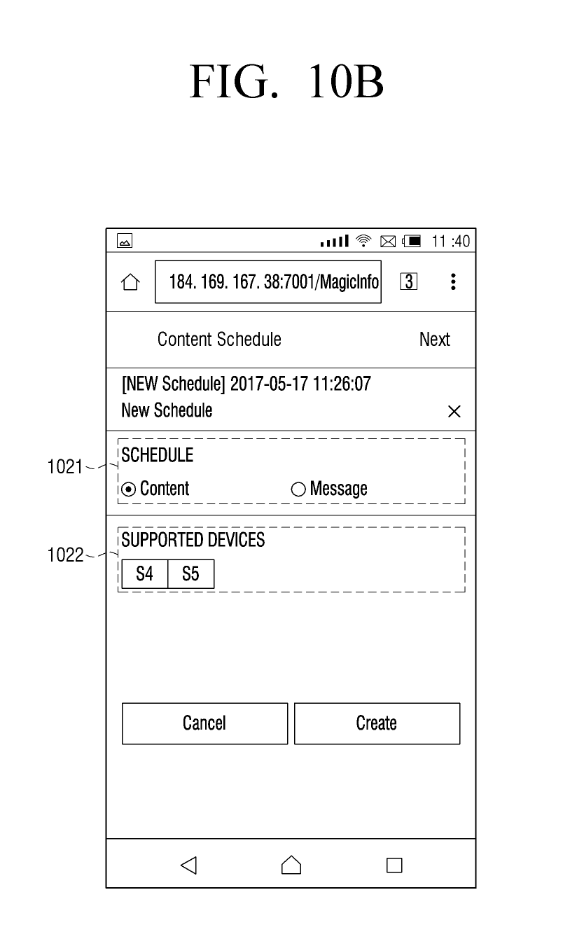

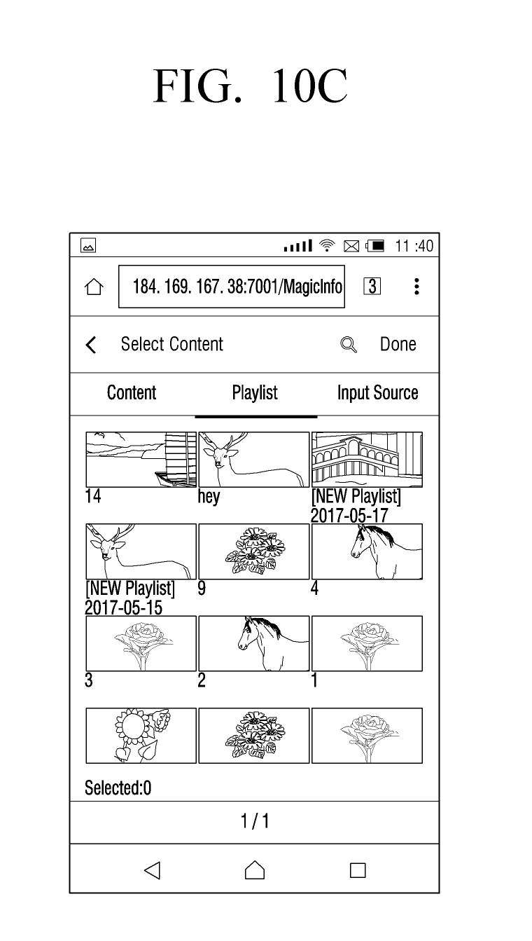

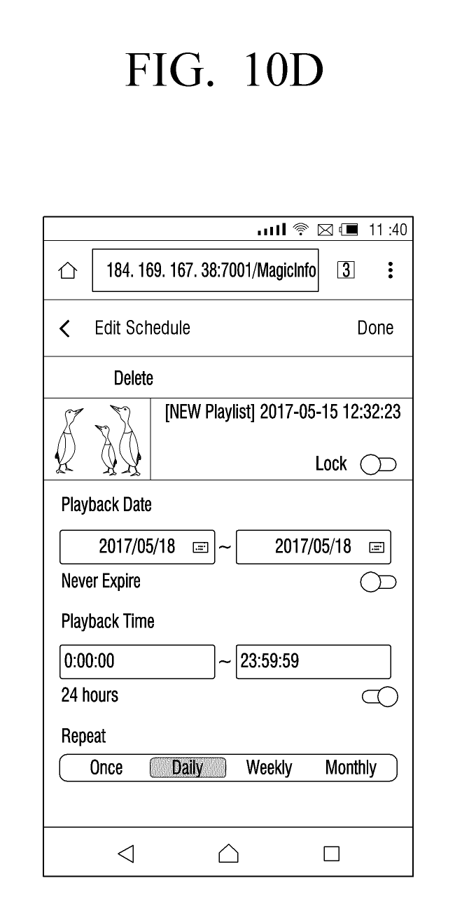

FIGS. 10A, 10B, 100, 10D and 10E illustrate an example of a schedule input method in accordance with an example embodiment.

For example, as illustrated in FIG. 10A, if a schedule generation command is input via a schedule generation button 1010, the electronic device 100 may input a schedule through the process illustrated in FIGS. 10B to 10D.

As illustrated in FIG. 10B, the electronic device 100 may include a schedule type 1021 and a model type 1022 for determining a type of the display device 200 for transmitting a schedule. The schedule type 1021 may include at least one of a content type or a message type. The model type may include the information about the display device 200 connected with the electronic device 100.

If the schedule type 1021 and the model type 1022 are selected, the electronic device 100 may display a list of content (or messages) to be transmitted to the display device 200 as illustrated in FIG. 100. The displayed list of content may vary depending on a specification of the display device 200.

If the schedule type 1021, the model type 1022, and the content to be transmitted are selected through a UI screen illustrated in FIGS. 10A, 10B, and 100, the electronic device 100 may set a start date and an end date, a start time and an end time of a schedule, a repetition period, etc. as illustrated in FIG. 10D. The electronic device 100 may determine a schedule which is input lastly as the highest priority schedule. However, the example embodiments are not limited to the above example, and a schedule priority may be determined by a user command.

If the inputting of a schedule via the UI illustrated in FIGS. 10A, 10B, 100 and 10D is completed, the electronic device 100 may add and display the input schedule in the schedule management UI. The displayed schedule management UI may be displayed in various ways by the aforementioned methods described in the description of FIGS. 3 to 8.

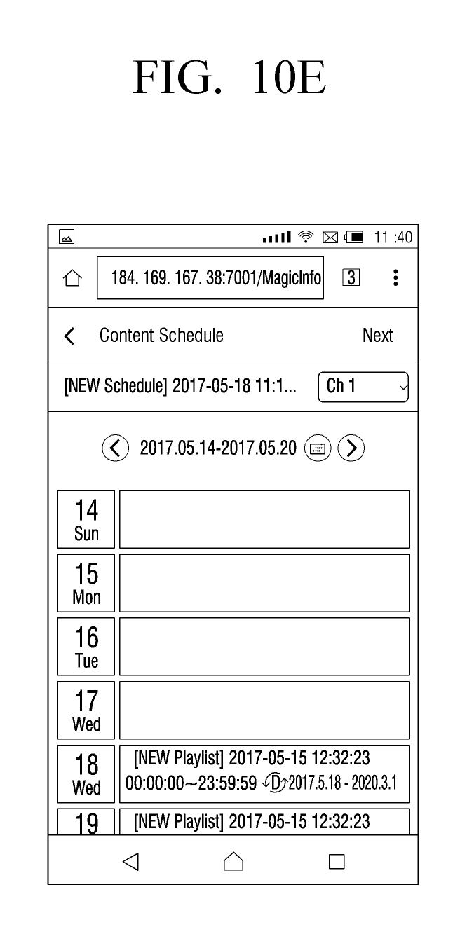

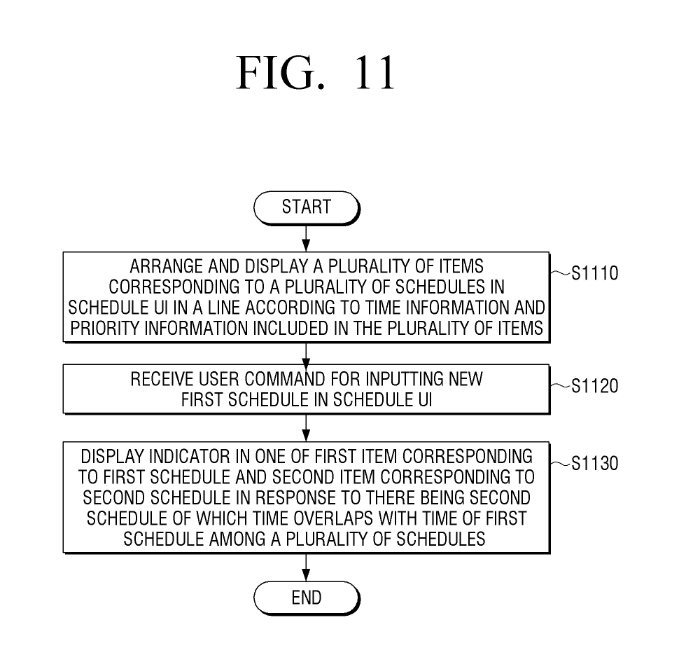

FIG. 11 is a flowchart illustrating an example of a schedule UI providing method in accordance with an example embodiment.

The electronic device 100 may display a plurality of items corresponding to a plurality of schedules in a schedule UI. The plurality of items may include time information and priority information, and may be displayed in a line in the schedule UI according to the included time information and priority information (S1110). The plurality of schedule items may be generated and displayed by the method described in the description of FIGS. 10A to 10E.

When a user command for inputting a new first schedule in the schedule UI is received, the electronic device 100 may identify whether there is a schedule of which time overlaps with the time of the first schedule among the plurality of schedules (S1120).

If there is the second schedule of which time overlaps with the time of the first schedule, the electronic device 100 may display an indicator in one of the first item corresponding to the first schedule and the second item corresponding to the second schedule in accordance with a priority of the first schedule and the second schedule (S1130). For example, if a priority of the second schedule is higher than a priority of the first schedule, the electronic device 100 may display an indicator in the first item. The displayed indicator may be relevant to the second schedule or the second item. For example, the color of the indicator displayed in the first item may be the same as the color of the second item.

According to one or more aforementioned example embodiments above, the schedule UI management method may be implemented as a program and be provided in a display device. Also, the program including the displaying method may be stored in a non-transitory computer readable medium and provided.

A non-transitory computer readable recording medium may refer to a machine-readable medium or device that stores data semi-permanently and not for a short period of time, such as a register, cache, memory, and the like. The aforementioned applications or programs may be stored in a non-transitory computer readable medium such as a compact disc (CD), a digital versatile disc (DVD), a hard disk, a Blu-ray disc, a universal serial bus (USB) stick, a memory card, a ROM, etc. and be provided.

The foregoing example embodiments and advantages are merely examples and are not to be construed as limiting the example embodiments. The description of the example embodiments is intended to be illustrative, and not to limit the scope of the inventive concept, as defined by the appended claims, and many alternatives, modifications, and variations will be apparent to those skilled in the art.

1. A schedule User Interface (UI) providing method of an electronic device, the method comprising:
arranging and displaying a plurality of items corresponding to a plurality of schedules in a line according to time information and priority information included in the plurality of items in a schedule UI;
receiving a user command for inputting a new first schedule in the schedule UI; and
in response to a second schedule of which time overlaps with time of the input first schedule being present among the plurality of schedules, displaying an indicator in one of a first item corresponding to the first schedule and a second item corresponding to the second schedule according to a priority of the first schedule and the second schedule.

2. The method of claim 1, wherein the displaying an indicator comprises displaying an indicator in an additional item with a low priority between the first item and the second item.

3. The method of claim 1, wherein the plurality of items have priorities such that an item which is input later has a higher priority according to an order of input of the plurality of items.

4. The method of claim 1, wherein the indicator is displayed in a bar shape in at least one of up, down, left and right sides of an additional item.

5. The method of claim 1, wherein the plurality of items are disposed such that an additional item with an earlier start time is disposed on an upper end, and any item with a later start time is disposed on a lower end according to a start time of the schedule.

6. The method of claim 5, wherein in response to a schedule start time of at least two items among the plurality of items being a same, another item with a higher priority between the at least two items is disposed on an upper end, and a further item with a lower priority is disposed on a lower end.

7. The method of claim 2, wherein the indicator displayed in the additional item with a lower priority has at least one of a shape, a color, and a brightness which correspond to the additional item with a higher priority.

8. The method of claim 2, wherein the displaying an indicator comprises, in response to there being a plurality of schedules of which time overlaps with time of the first schedule, a plurality of indicators corresponding to a schedule with a higher priority than a priority of the first schedule are displayed in the first item corresponding to the first schedule, and
wherein the plurality of indicators are arranged and displayed according to a priority of a plurality of items corresponding to the plurality of indicators in the first item.

9. The method of claim 1, further comprising:
displaying, by the schedule UI, a summary item which summarizes a schedule according to time information and priority information included in the plurality of items,
wherein the summary item displays a plurality of indicators corresponding to the plurality of items in the summary item based on time information of the plurality of items, and
wherein in response to an indicator for the plurality of items overlapping with the summary item and being displayed, an indicator of an additional item with a higher priority among the plurality of items is displayed in the summary item.

10. The method of claim 1, further comprising:
in response to an input of an indicator user command for the indicator, displaying schedule information of an item corresponding to the indicator.

11. An electronic device comprising:
an input unit;
a display; and
a processor configured to:
control the display to arrange and display a plurality of items corresponding to a plurality of schedule in a line according to time information and priority information included in the plurality of items in a schedule User Interface (UI),
receive a user command for inputting a new first schedule in the schedule UI via the input unit, and
in response to a second schedule of which time overlaps with time of the first schedule being present among the plurality of schedules, control the display to display an indicator in one of a first item corresponding to the first schedule and a second item corresponding to the second schedule according to a priority of the first schedule and the second schedule and display the first item in the schedule UI according to time information and priority information included in the first item.

12. The electronic device of claim 11, wherein the processor is further configured to control the display to display the indicator in an additional item with a low priority between the first item and the second item.

13. The electronic device of claim 11, wherein the plurality of items have priorities such that an additional item which is input later has a higher priority according to an order of input of the plurality of items.

14. The electronic device of claim 11, wherein the processor is further configured to control the display to display the indicator in a bar shape in at least one of up, down, left and right sides of an additional item.

15. The electronic device of claim 11, wherein the processor is further configured to control the display to dispose the plurality of items such that an additional item with an earlier start time is disposed on an upper end, and another item with a later start time is disposed on a lower end according to a start time of the schedule.

16. The electronic device of claim 15, wherein the processor is further configured to, in response to a schedule start time of at least two items among the plurality of items being same, control the display to dispose a further item with a higher priority between the at least two items on an upper end and dispose a still further item with a lower priority on a lower end.

17. The electronic device of claim 12, wherein the indicator displayed in the additional item with a lower priority has at least one of a shape, a color, and a brightness which correspond to the additional item with a higher priority.

18. The electronic device of claim 12, wherein the processor is further configured to, in response to there being a plurality of schedules of which time overlaps with time of the first schedule, control the display to display a plurality of indicators corresponding to a schedule with a higher priority than a priority of the first schedule in the first item corresponding to the first schedule, and
wherein the processor is further configured to control the display to arrange and display the plurality of indicators according to a priority of a plurality of items corresponding to the plurality of indicators and display in the first item.

19. The electronic device of claim 11, wherein the processor is further configured to:
control the display to display a summary item which summarizes a schedule according to time information and priority information included in the plurality of items by the schedule UI,
control the display to display a plurality of indicators corresponding to the plurality of items in the summary item based on time information of the plurality of items, and
in response to an indicator for the plurality of items overlapping with the summary item and being displayed, control the display to display an indicator of an additional item with a higher priority among the plurality of items in the summary item.

20. The electronic device of claim 11, wherein the processor is further configured to, in response to receiving a user command for the indicator, control the display to display schedule information of an item corresponding to the indicator.
